(19) United States
(12) Patent Application Publication
(10) Pub. No.: US 2021/0295734 A1
(43) Pub. Date: Sep. 23, 2021

(54) Automated Syllabus

(71) Applicant: Giovanni Estrada, Boca Raton, FL (US)

(72) Inventor: Giovanni Estrada, Boca Raton, FL (US)

(21) Appl. No.: 17/076,247

(22) Filed: Oct. 21, 2020

Related U.S. Application Data
(60) Provisional application No. 62/912,993, filed on Oct. 9, 2019.

(51) Int. Cl. G09B 19/00; G06N 20/00; G09B 5/06

(52) U.S. Cl. CPC G09B 19/00; G09B 5/065; G06N 20/00

(57) ABSTRACT

Systems and methods are disclosed to manage learning for a student or group of students by capturing images of one or more syllabi using a mobile device or smart phone; detecting keywords in the one or more syllabi; determining deadlines based on requirements of the syllabi; displaying important information extracted from the syllabi; generating notifications for the student based on the deadlines extracted from the syllabi; automatically placing the students into one or more student groups based on student class registrations wherein students can communicate via chat and share class recordings, notes and other files; and allowing professors, teachers, or instructors to update this information in real-time.

The present application claims priority to Provisional Application Ser. No. 62/912,993 filed Oct. 9, 2019, the content of which is incorporated by reference.

### BACKGROUND

The present invention relates to a system for managing the learning process of students in courses of study guided and dictated by a syllabus or written lesson plan created by a teacher or professor. More particularly, this invention relates to a system of automating the syllabi or written lesson plans for various courses of study and converting them into a simplistic digital interface that allows students to more easily follow their guidelines and to keep up with the important dates and assignments listed therein using a mobile device or computer. More particularly still, this invention relates to a system that uses optimal character recognition (OCR) to extract important information from a plurality of syllabi or written lesson plans to create a unified digital interface for individual students, teachers, instructors, and professors to better manage and keep up with their various courses of study.

A syllabus or written lesson plan is a document that communicates information about a specific course of study, usually written by a teacher, professor, or instructor and that defines the expectations and responsibilities of students enrolled in that course. A syllabus is a student's guide to a course of study as it often includes course name, meeting times and locations, course policies, rules and regulations, required texts for reading, and a schedule of the assignments, quizzes, tests, and course materials to be covered or taught in the course. An exemplary course syllabus is shown in FIG. 1A and an exemplary class schedule typically found in a course syllabus is shown in FIG. 1B.

Grade school, high school, and university students are handed several syllabi every semester or quarterly period for their classes and courses of study, and students often misplace them or neglect them by failing to regularly check them for upcoming important dates, guidelines, assignments, and other information often found therein. In these settings, the syllabus is a document designed for frequent reference, meant for students to regularly look back to them for important information about the course of study to which they refer. Professors, teachers, and instructors also benefit from frequent reference to the syllabi for their respective courses of study requiring them to keep up with the document in order to abide by its provisions. In any course of study, things may happen that require changes to the initial plan as prescribed in a syllabus. Teachers, professors, and instructors often have to print and/or distribute new or updated versions of a syllabus upon any modification thereto, creating a greater potential for confusion in following this important document.

There are plenty of learning management systems (LMS) that may be considered prior art to this invention in that they are generally designed to improve the learning processes in courses of study and to help foster communication of important information between students and teachers, professors, and instructors in their respective shared course(s). These platforms are generally available on mobile devices and use digital interfaces that allow users to manage their course loads whether as students or instructors. However, the existing LMS platforms require teachers, professors, and instructors to manually input information for courses of study, or to upload digital copies of syllabi in PDF, JPG, DocX or other static formats for online or mobile viewing. These types of systems, and all other systems that my be considered prior art, still require teachers, professors, and instructors, to undergo the duplicitous task of writing a syllabus or lesson plan out and to then log in and manually enter the same information onto the platform for other users to view. Similarly, if uploaded, the LMS platforms typically offer the syllabus or lesson plan as a static document for users to read and refer back to at their own discretion, without any ability to modify the document. Syllabi are often many pages long and require parsing, scrolling, and locating of the important information that a reader might seek.

There is no currently existing system that automates the syllabus document, extracts the important information, and creates its own simplified digital interface to act as a roadmap for users to follow along in a course of study the way this invention does. By eliminating the need for constant reference to a static document so essential to a course of study, and grouping the users bound by it into a closed network of communication with a shared roadmap for the course based on information automatically extracted from the document, this invention improves the learning process shared by all syllabus users in a way that no prior art does.

### SUMMARY

This patent application discloses and claims a useful and nonobvious invention for a simplified and streamlined learning management system that automatically creates a multifaceted digital learning roadmap for students, teachers, professors, and instructors using information extracted from the captured image or photocopy of a course syllabus or written lesson plan or plurality thereof. Systems and methods are disclosed for photographing, uploading, rendering, detecting key words, and converting the important information provided in one or more syllabus or written lesson plan into an easy to manage digital interface that notifies students, teachers, professors, and instructors of important dates, locations, lesson topics, assignments, quizzes, and tests extracted therefrom and allows for open communication and sharing of documents and class recordings amongst a closed group of members of a given course.

Advantages of the system may include one or more of the following. The system eliminates the need for continued reference back to a static document that dictates the flow of a course of study and automatically creates a suite of tools to help manage and maintain keen awareness of the most important and urgent information from that static document in a closed network. The system transforms the nature of this important document from one that is static and that must be replaced by newer versions for any needed modifications and converts it into a living roadmap that teachers, professors, and instructors can modify in real-time for all students to see and to follow with much less confusion. The system integrates an innovative learning management system into what is essentially a closed social networking platform specific to each course in that it allows the users enrolled in that course to use chat communication amongst themselves and to capture and upload audio, video, photographs, and other files relevant to the course visible to all the other users enrolled in the course. The system allows users to simply take a picture of one or more syllabi or written lesson plans that it then uses to automatically populate a comprehensive calendar showing all the important dates and deadlines found in each syllabi. The system thus creates for individual students, teachers, professors, and instructors a comprehensive roadmap interface for following the syllabus guidelines of multiple courses of study at once. The system thus creates collectively for any group of users in any given shared class or course of study a shared roadmap interface for that course easily updatable in real time by the teacher, professor, or instructor of that course, eliminating the prevalence of confusion and duplicity. The system is simple enough for use in any classroom setting at any level and can be paired with other LMS platforms for improved functionality thereof. The system is optimized for use on mobile devices which are increasingly ever present on students' persons allowing virtual access to all syllabi and important course information at all times. The system allows for schools of all sizes to maintain and manage a closed network of these shared roadmap interfaces with oversight and the ability to monitor both teacher and student engagement therein by use of a localized school dashboard accessible via web browser.

### BRIEF DESCRIPTION OF THE FIGURES

FIG. 1A shows an another exemplary course syllabus to be scanned;

FIG. 1B shows an exemplary class schedule from a typical course syllabus to be scanned;

FIG. 2A shows an exemplary process by which the invention is adopted and set up by a school, university, or learning institution;

FIG. 2B details and describes the different classes of system users

FIG. 2C shows an exemplary system process of extracting important data from a scanned syllabus using OCR;

FIG. 2D shows an exemplary system process to automate multiple scanned syllabi into one easy to follow digital interface designed to function using the mobile application's various features to provide for improved learning management based on the data from the various syllabi.

FIGS. 2E-2F show in more details the exemplary system processes run by the system of FIG. 2A;

FIGS. 2G-2H show in more details the exemplary system processes run by the mobile application software of FIG. 2A;

FIGS. 3A-3P show exemplary user interface (UI) layouts for a mobile app to facilitate learning management using information extracted from course syllabi;

FIGS. 4A-4I show exemplary UI layouts for a spool dashboard interface.

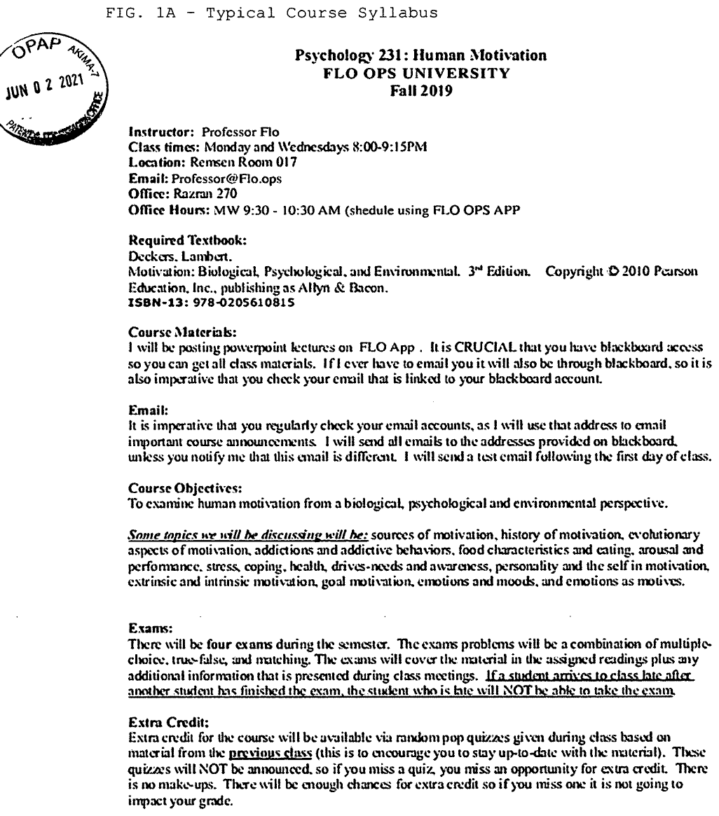

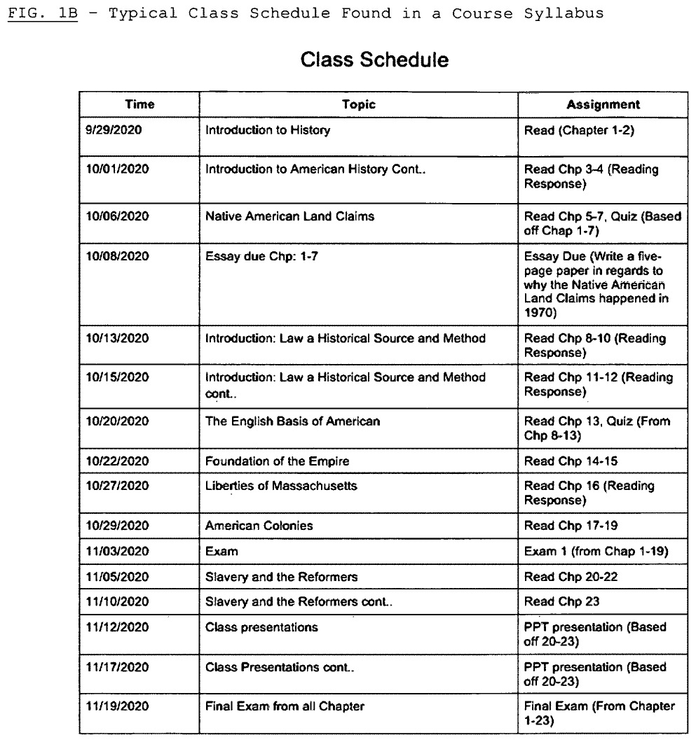

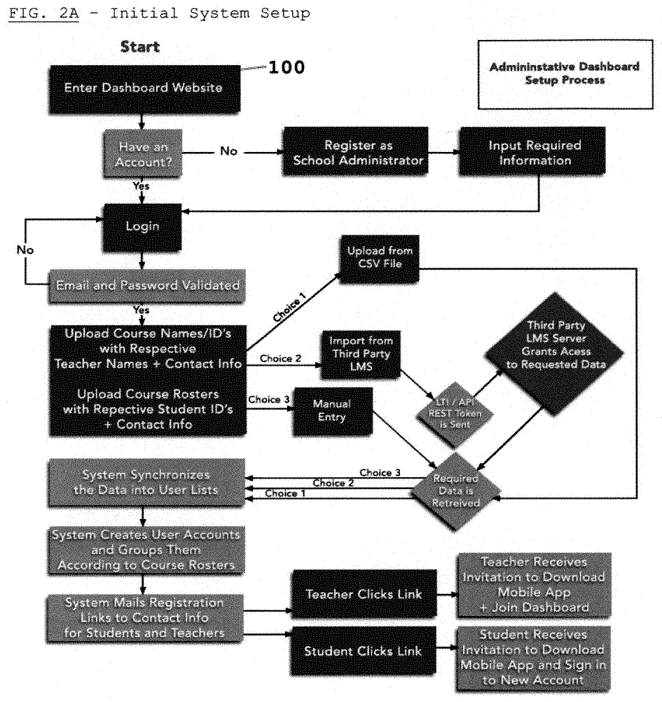

### SYSTEM OVERVIEW

The system claimed is that combines multiple features and processes into one streamlined simplified and automated framework for learning management that is easy enough for use in kindergarten classrooms and efficient and practical enough for use in large university lecture halls. The system combines a multi featured Learning Management Software (LMS) mobile application with an online course management “Administrative Dashboard” controlled and operated by a given school to create a unique system that more efficiently allows that school to manage its curricula in a way that helps students keep up with course materials by automatically converting its teachers' lesson plans and syllabi into an easy to follow mobile roadmap to academic success. The mobile application, as one embodiment, uses the camera of a mobile device to snap photos of a Syllabus and uses Optical Character Recognition (OCR) to convert the text of the document into editable data that is then populated into the mobile application's various features including but not limited to calendars, archives, newsfeeds, and course information pages.

The mobile application has different user-interfaces, one for teachers and administrators and one for students, both of which having focus on important upcoming dates for each Course. The mobile application features a scrollable Newsfeed showing all upcoming important dates and deadlines for each course the user is enrolled in, a chat thread for each course allowing students to communicate with classmates and with the professor, a calendar that organizes all dates and assignments into daily or monthly schedules, and an archive for each course that allows users to record audio/video or share notes and other course materials uploaded by students or professors—all in one easy to use framework, all extracted and parsed from a scanned photo of a syllabus or lesson plan.

The system combines this mobile application with the online administrative dashboard that allows teachers to manually edit course information and listed dates making changes in real-time for mobile application users to see. The dashboard also allows for “Managers” or system administrators to add or remove courses, add and remove teachers and remove to courses, or add or remove lessons or topics from syllabi.

The system's proprietary mix of data extraction technology and its simple yet advanced road-mapping of information into a streamlined mobile syllabus with chat and share features and combined with the administrative dashboard for managerial oversight allows for students and teachers to be better connected and to stay on the same page at all times. This automates the lesson plans for teachers, and simplifies and socializes it for students. It's simple enough for elementary school aged children to use and it also allows their parents to keep up with the teacher's assignments and deadlines. Finally, it creates for a school of any size a unique closed-loop network of smaller closed-loop networks in that each school operates independently with its own administrative dashboard able to manage and control their school's LMS platform accessible on the mobile application. The platform functions as an academic social network, with students able to record, upload, and share materials amongst classmates, and to chat/discuss those same materials in much the same way many students have become accustomed to doing online in other settings and on other noneducational mobile applications.

### DETAILED DESCRIPTION OF THE INVENTION

The following description of exemplary embodiments of the invention is not intended to limit in any way the scope of the invention to these exemplary embodiments but is presented for the purpose of enabling a person skilled in the art to make and use the invention.

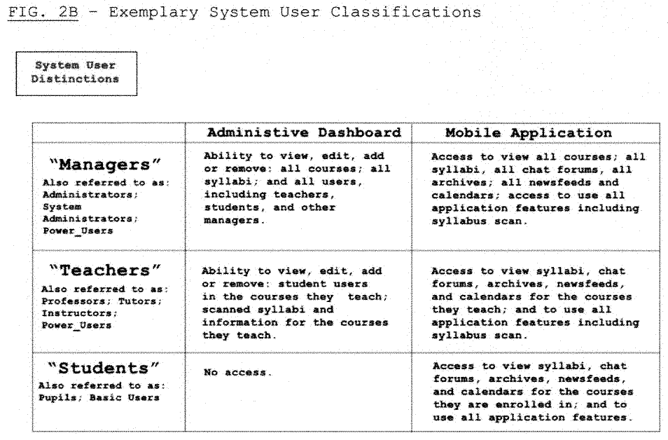

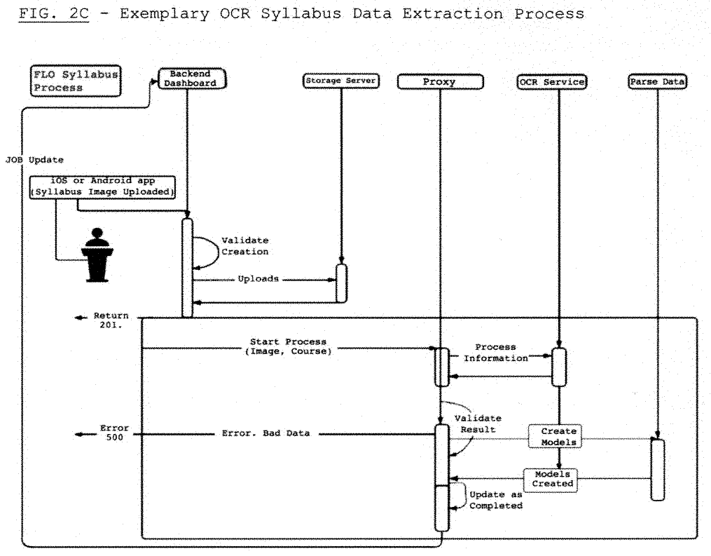

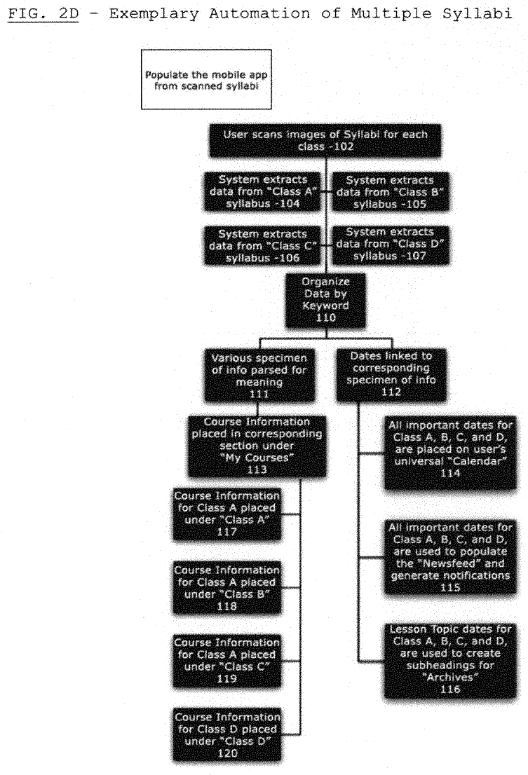

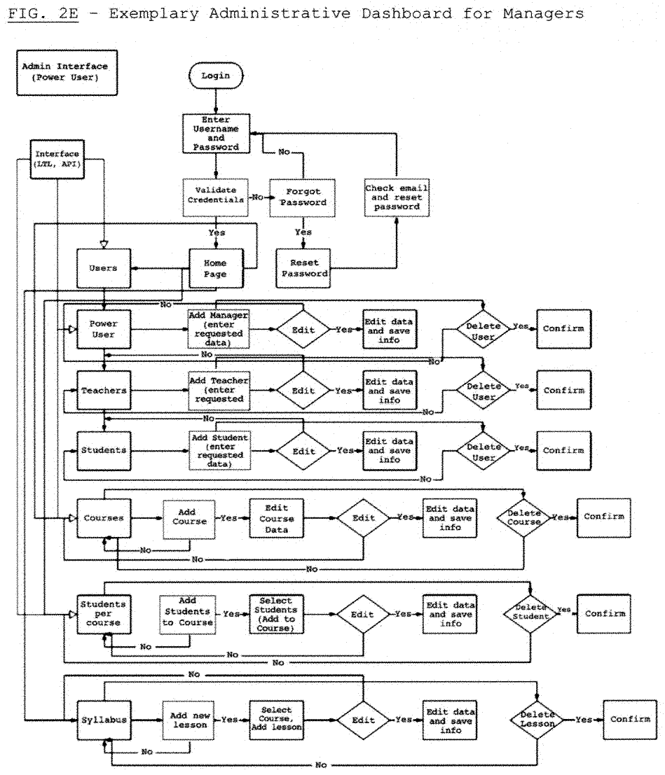

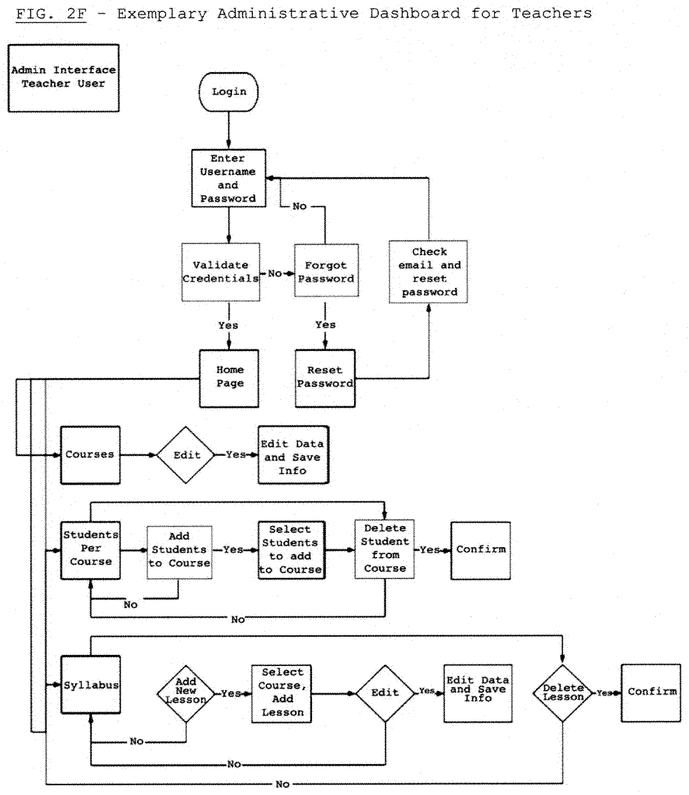

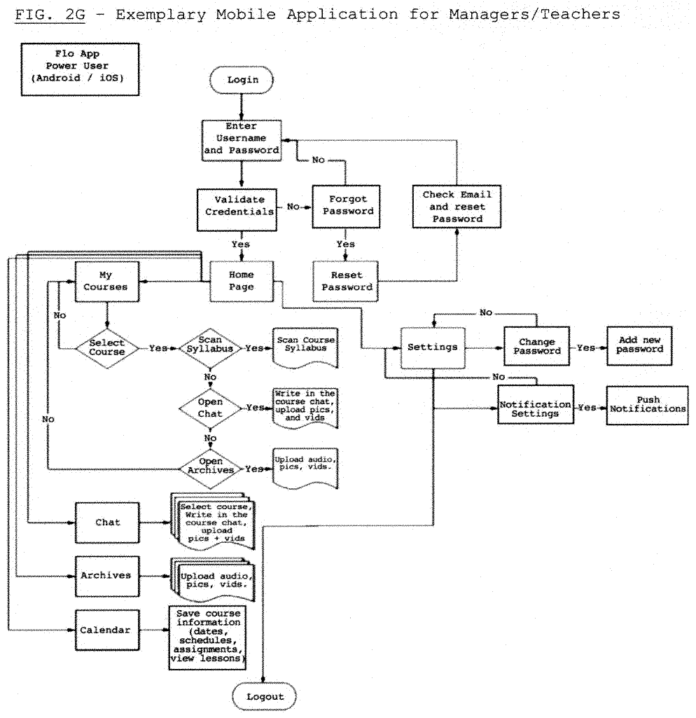

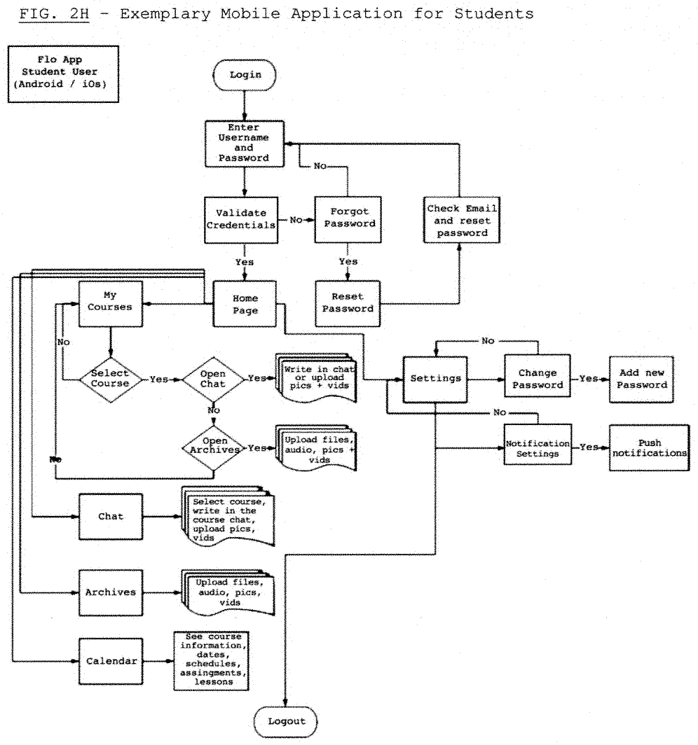

FIG. 2A shows an exemplary process by which the invention is adopted and set up by a school, university, or learning institution. A school representative, usually an IT Director, school principal, department chair, or other high ranking member of the school administration is given access to start a new network of courses and users for the school. The school administrator accomplishes this by first visiting the Administrative Dashboard website 100 via web browser. This website is the portal through which any school, university, or learning institution is able to create and access its own individual network complete with a unique server, a unique network of courses and users, and a unique Administrative Dashboard for monitoring and controlling said unique network. Upon entering the website, the school administrator is required to either register a new account or login by entering the preapproved account credentials.

Once logged in, the school administrator is prompted to upload a list of the school's courses using unique names or other unique identifiers for each unique course along with the names of or other unique identifiers for the teacher, professor, or instructor of each respective course, and the roster of names or other unique indentifiers of students enrolled in each respective course, and contact information for each student and teacher, usually an email address to receive a system registration link. This information can be uploaded into the administrative dashboard in one of three ways: as a properly tabulated plain-text spreadsheet or similar comma-separated values (CSV) file, by importing the data from a third-party software or data server, or by entering the information manually. If the required information for each course, teacher, and course roster is entered manually or uploaded as a properly tabulated plain-text spreadsheet or CSV file, the system extracts the data and synchronizes it into a Course List and a User List. If the data is to be imported from a third-party software or data server, the required request for access and authentication is sent to the third-party, whether via proxy, Learning Tools Interoperability (LTI) integration, a Representational State Transfer (REST) styled Application Programming Interface (API) token, or other method. Upon confirmation and receiving access to view and retrieve the requested data from the third-party system or server, the system extracts the necessary data and synchronizes it into a User List.

The school administrator has the ability to edit and manipulate the generated User List, with the ability to add Teachers, Students, or other Managers into the system via the administrative dashboard. Each individual Administrative Dashboard (typically unique to one school, university, or learning institution) may register an unlimited amount of users, with each user falling into one of three categories: Managers/Administrators, Teachers, and Students. FIG. 2B details and describes the different classes of system users for each Administrative Dashboard and their respective permissions and abilities to access and use both the administrative dashboard and mobile application.

Once the data is synchronized and the Course and User Lists are generated, the system creates accounts for each user and groups the them into their respective courses. The system then sends an email to the contact info for each user with a URL link inviting teachers and managers to access the administrative dashboard and inviting all users to download the mobile application. Once the link is followed, and the application is downloaded to a mobile device, users are able to choose a unique password, verify that the account information (name or other unique identifier) is correct, and log into their already created account that is grouped according to their enrolled courses. In addition to their access to the mobile application, the user account created for teachers and managers allows them access to the administrative dashboard, though with different privileges as defined in FIG. 2B and further described below.

The crux of the invention though is the system user's ability to photograph or scan a syllabus or written lesson plan using the downloaded mobile application that then populates the mobile application with the important information extracted from the syllabus for other system users to view and follow along with. FIG. 2C shows an exemplary system process of extracting important data from a scanned syllabus using OCR. By storing these scanned images of the various syllabi in an organized database, the system allows for basic algorithmic machine learning, constantly improving on its ability to identify, extract, and organize key information from the images.

The system, through its mobile application, requests access to use the camera in a smart phone or mobile device. Optical Character Recognition (OCR) with pytesseract or other similar tool can be used to convert the text into editable and sortable data. To increase OCR accuracy, the image of the syllabus should have large image size, good light quality, and font that separates well from the background without skew or distortion. The image can be opened using openCV, or other similar tool, which is installed under the name cv2. The image may then need to be converted to a binary image if it is not already an image consisting only of black and white pixels. In one embodiment, the binary image is reached by grayscaling that takes the three RGB values of an image and transforms to a single value which represents a shade of grey. Since the binary image has a white background and black foreground, which are the letters or signs, the image may need to be inverted. This can be done by the bitwise not or other similar operation. Every pixel being 1 and thus white is turned to a black pixel and every pixel being 0 and thus black, is turned to a white pixel. Morphological operations are performed to remove noise around the characters. The image preprocessing applies erosion and dilation to remove noise. Text is then generated from the cleaned image.

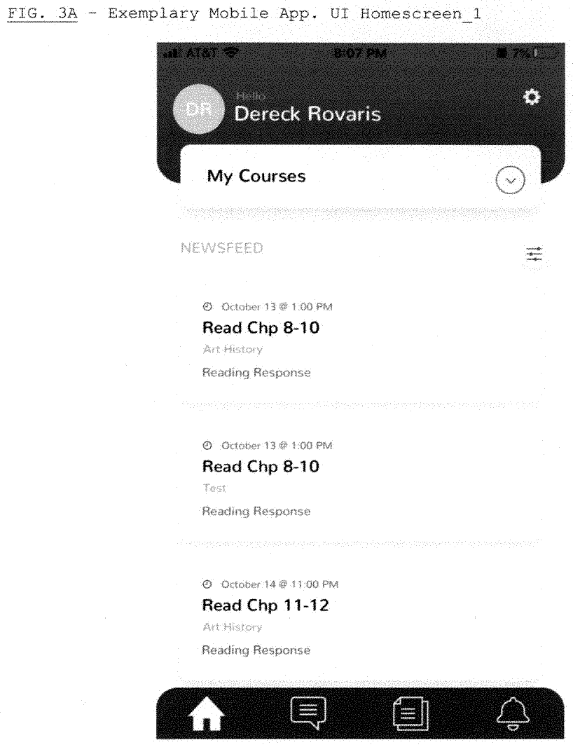

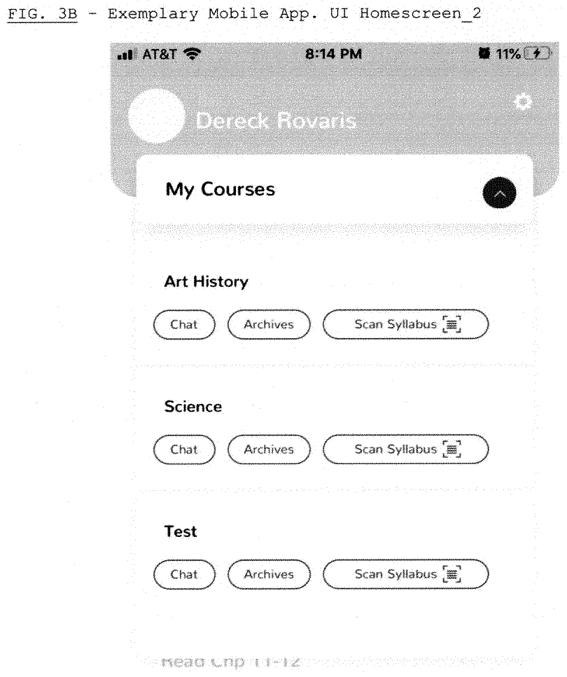

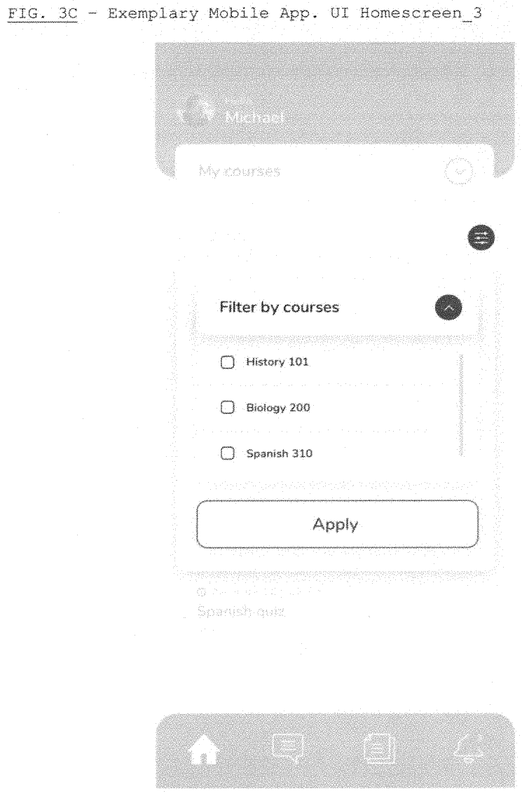

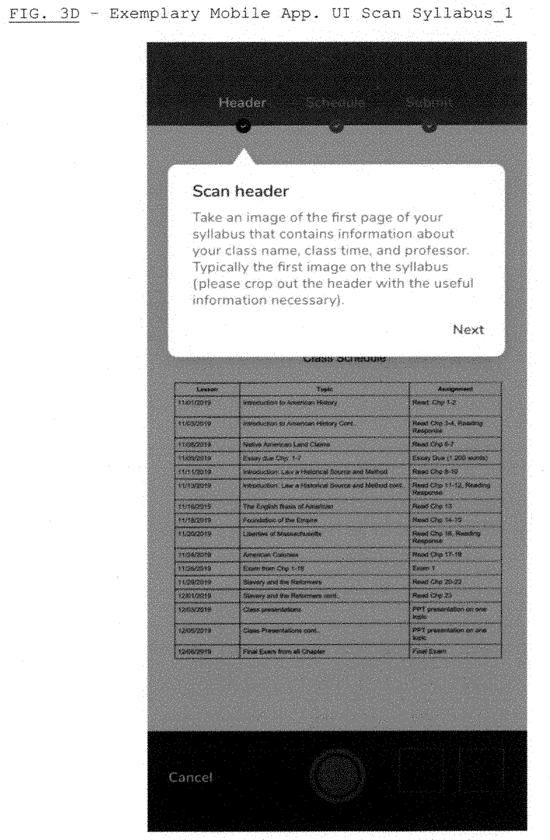

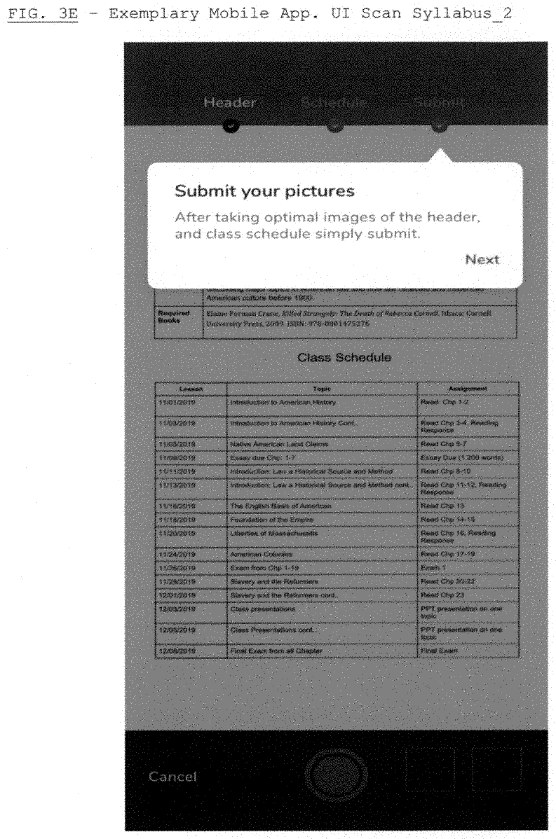

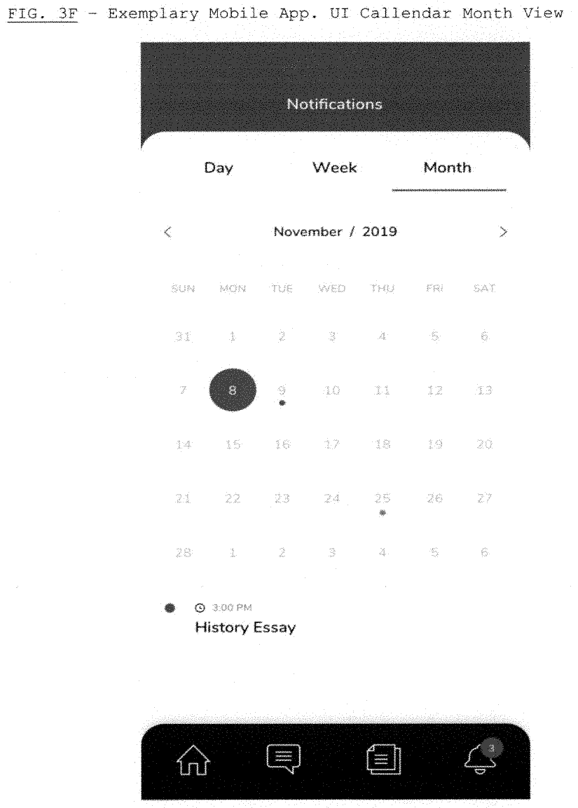

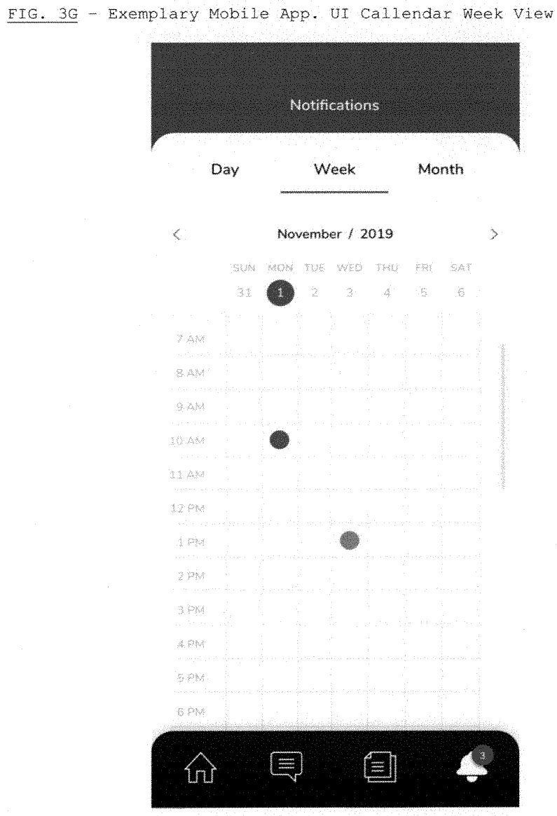

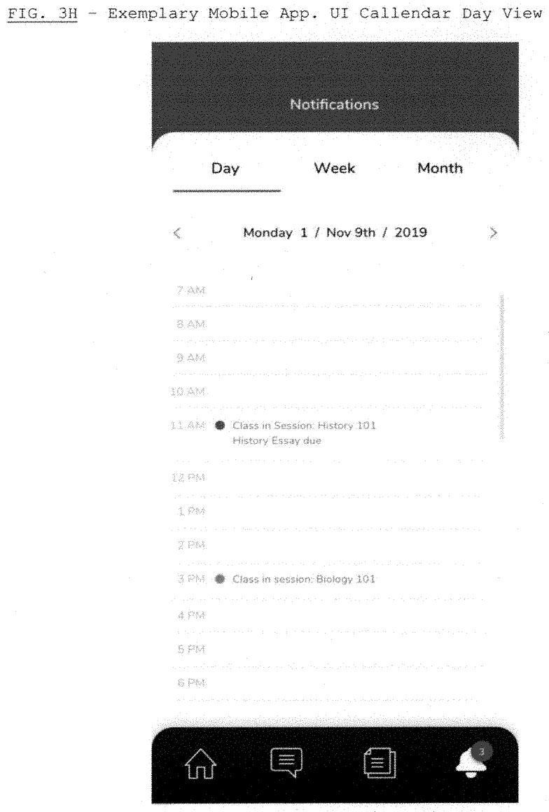

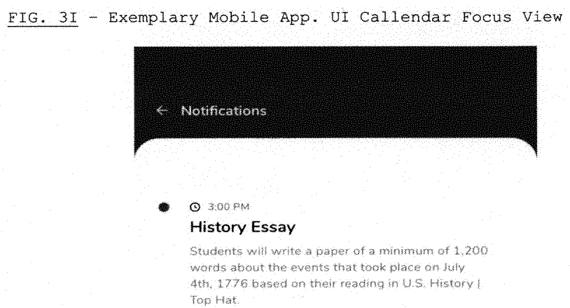

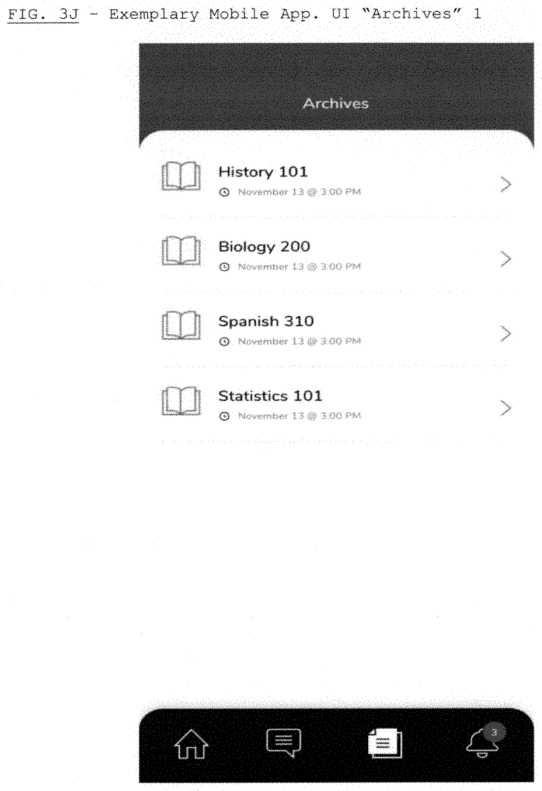

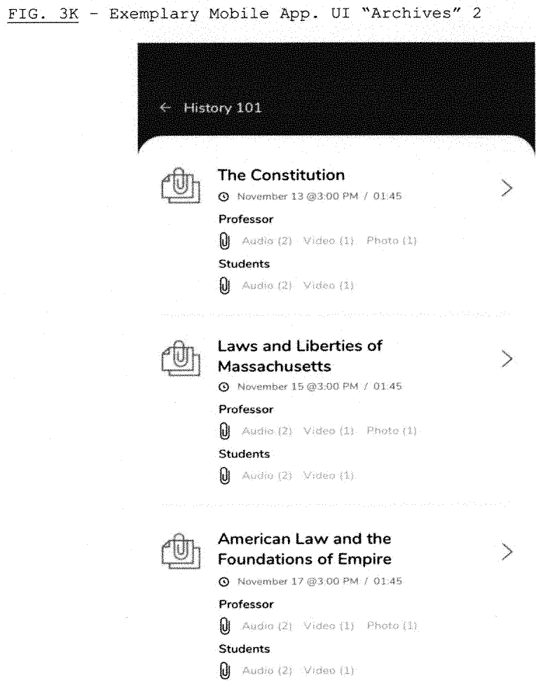

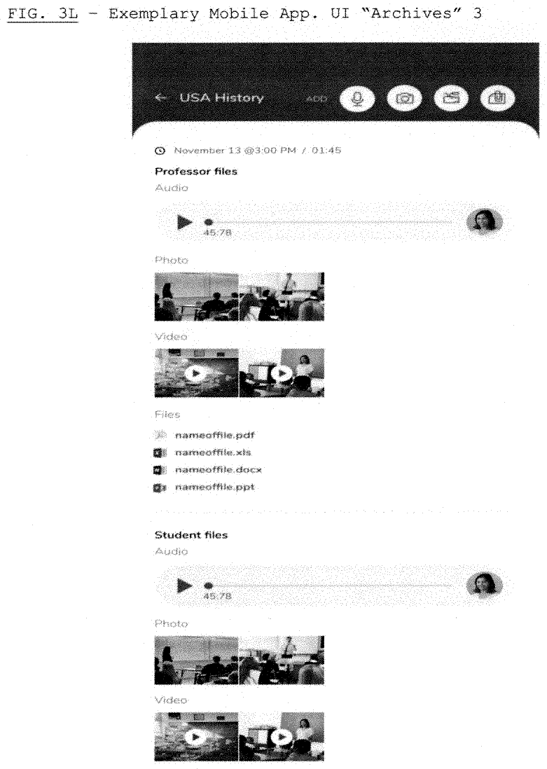

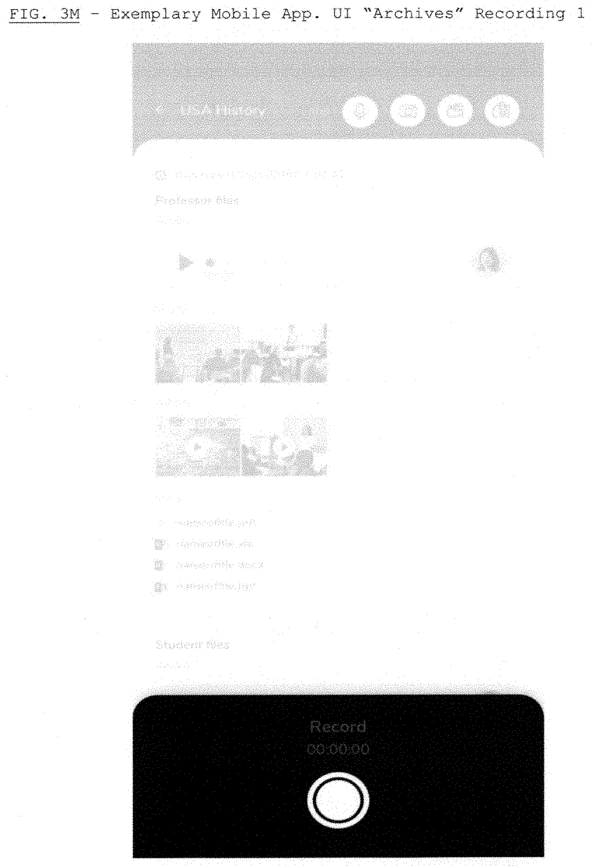

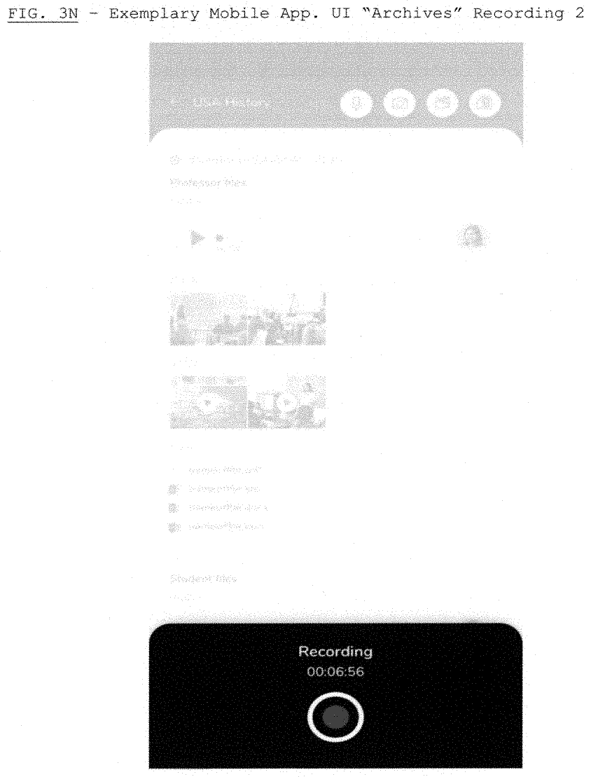

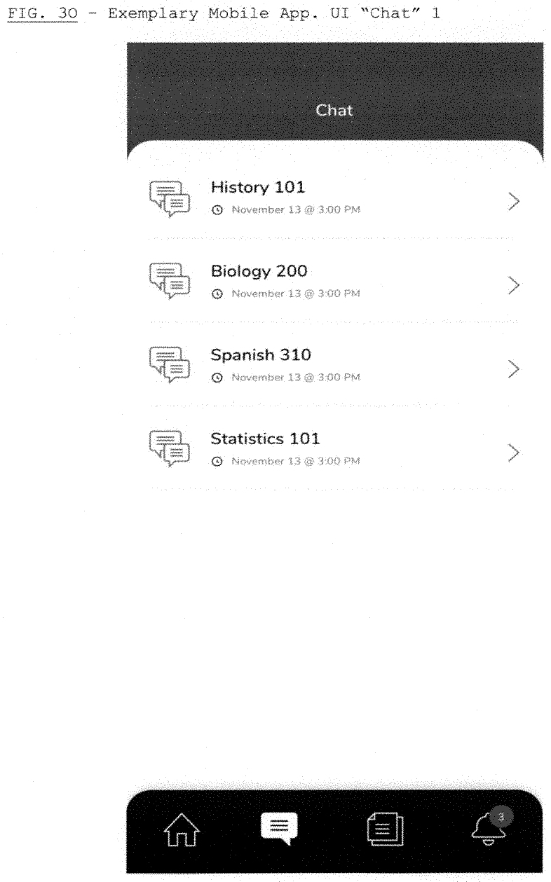

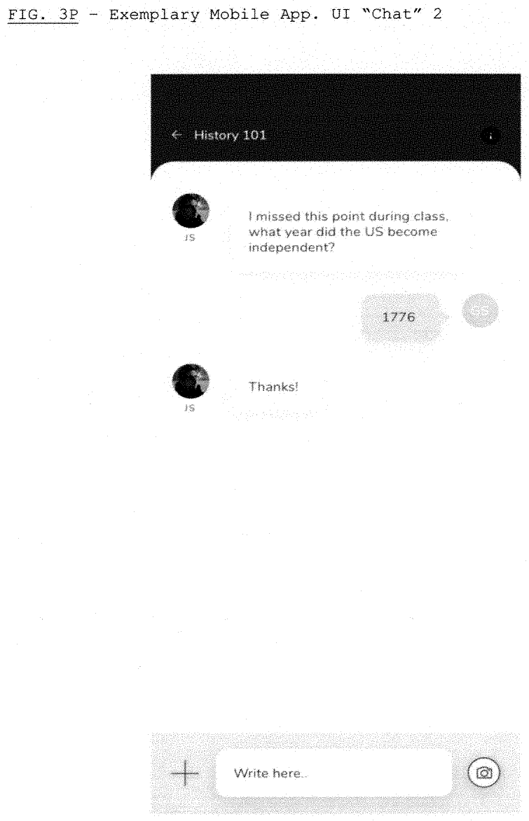

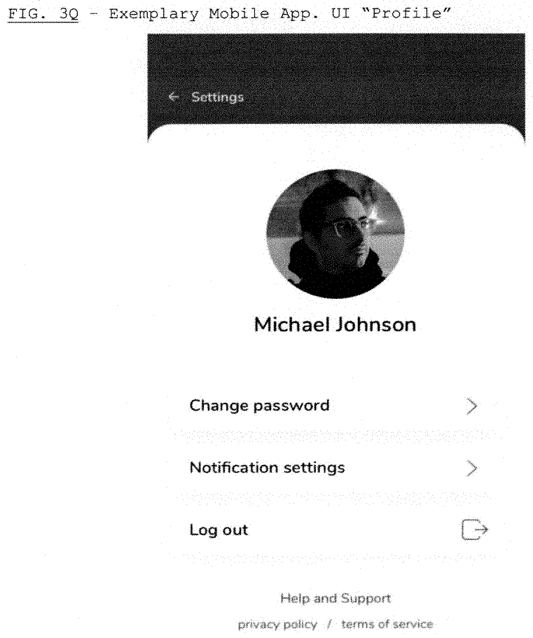

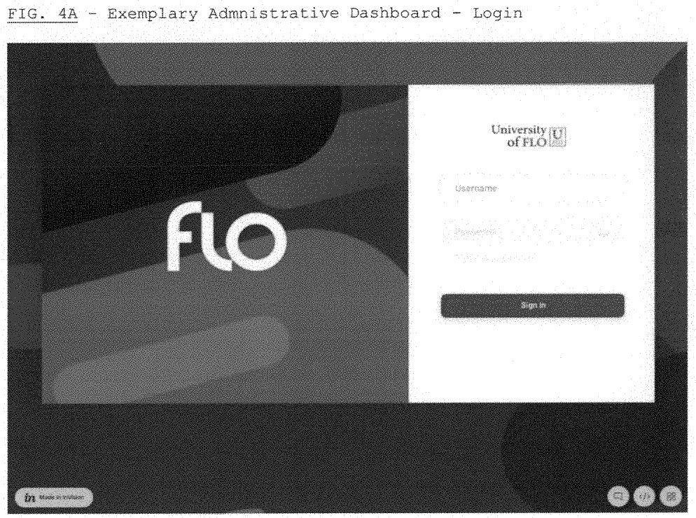

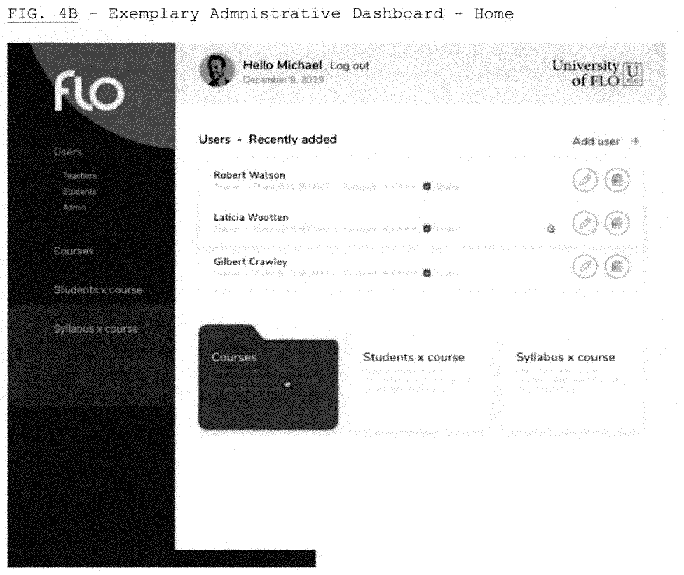

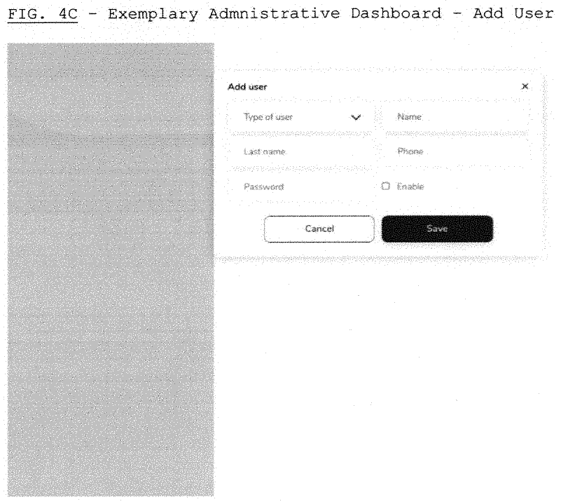

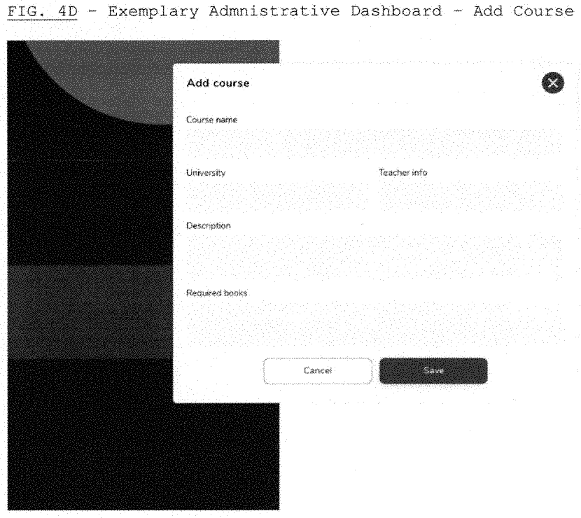

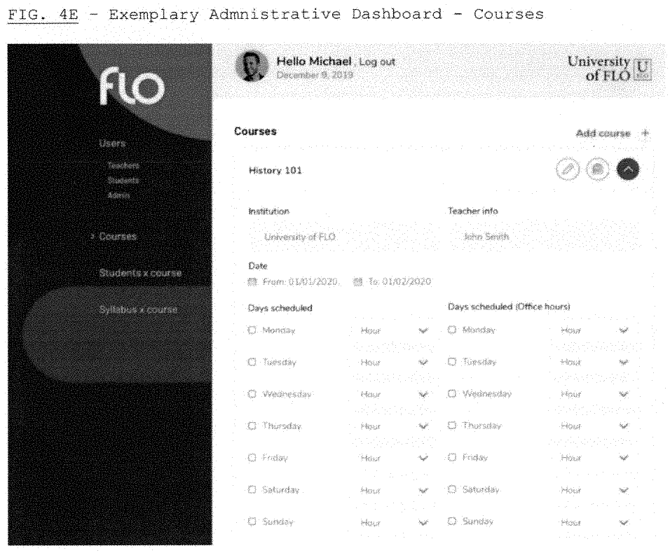

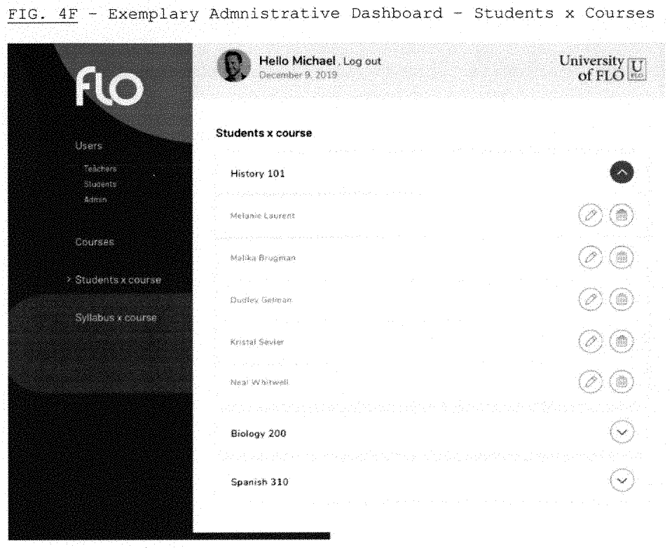

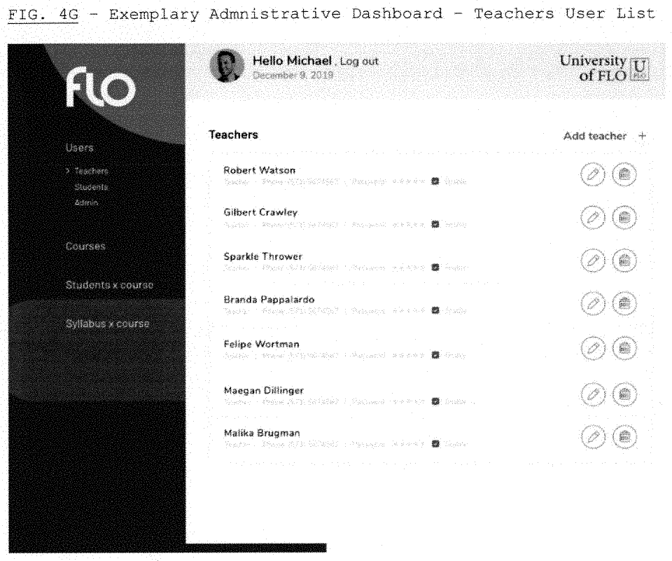

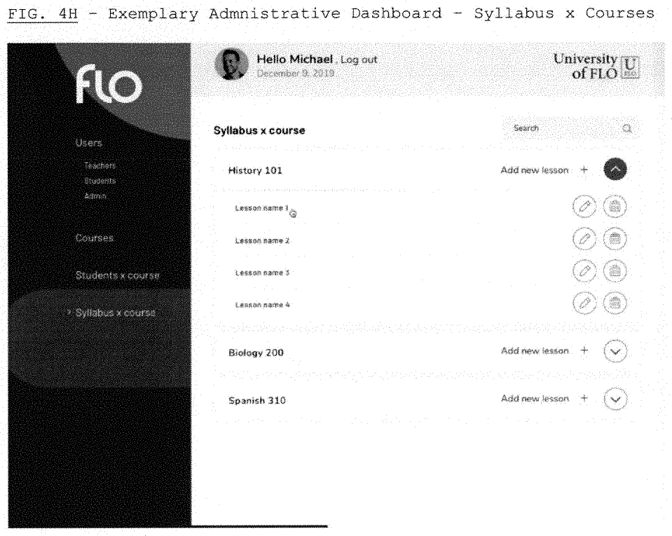

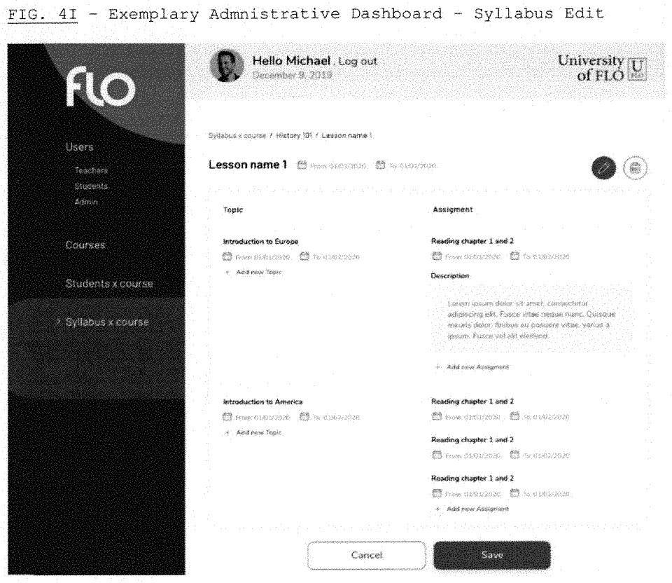

The system's mobile application is designed to make this process a bit easier however, in that it directs the user to take or upload clear photos of specific sections of a given syllabus, sections which are often already 100% text. See FIG. 3D-E The mobile application describes these sections as “the header” and “the schedule” though the information sought might easily be labeled differently or have no label at all on a given syllabus. Though not mandatory, by focusing in on these specific sections, the system is more easily able to extract the most important information from a given syllabus or written lesson plan like the class meeting times and locations, the office hours available, the topics to be covered and due dates for assignments, tests, and quizzes, etc.

FIG. 2C also shows an exemplary diagram of this process by which a Teacher, Professor, or Manager is able to snap or upload pictures of a syllabus and have it populate the mobile application with information for users to view and use. After selecting a Course on the mobile application's “My Courses” drop down list and selecting “Scan Syllabus,” (SEE FIGS. 3D-E) the mobile application opens the mobile device's camera (if granted access by the user upon initial request) and prompts the user to take two photos, one of the syllabus “Header” and one of the syllabus “Schedule.” The header usually includes basic information about the course like course title, location or class room, start date and end date, and professor's office hours. The schedule usually lists important dates and deadlines for a Course like quizzes, lectures, assignments, tests, etc. The mobile application will also allow the user to upload the photo from mobile device's internal library/storage of photos (if granted access to do so by the user). The system may then send these images to a cloud server and saves them in a storage server. It may then handle an asynchronous process to request the processing of these images using a proxy. This proxy may then call a third party service such as Amazon Textract, among others, for OCR to extract the texts from the images. The result provided by the OCR service is parsed by the system to classify, convert, and save key information in the system data base. Processing errors, if any, are sent via push notification to the end user. Successful processing of the data is also informed. The key information that is extracted from the syllabus Header and Schedule and saved in the system database is then used to populate the mobile application Course page originally selected by the Teacher, Professor, or Manager, including the Course class times, location, important dates, etc., all of which can later be manually edited by the Teacher, Professor, or Manager.

FIG. 2D shows an exemplary diagram of a system process to automate multiple scanned syllabi into one easy to follow digital interface designed to function using the mobile application's various features to provide for improved learning management based on the data from the various syllabi. A user begins by selecting “My Courses” on the mobile application, selecting a given course, and taking photos or scanning the respective syllabus 102 for that course. The user repeats this process for each course and syllabus. For the sake of example, the exemplary diagram assumes a user currently has four courses in the system, “Class A,” “Class B,” “Class C,” and “Class D.” The system then uses OCR as described above to extract the data from each respective syllabus one at a time 104-107. The system then organizes the data from each syllabus based on keywords typically found in syllabi 110. From this organization of the data, the system is able to populate the information into the mobile application's various features to create the digital framework for improved learning management. The various items of information that describe and define a given course is parsed 111 and placed as a text subheading under the course to which it corresponds in the “My Courses” drop down list for that user 117-120 (SEE FIG. 3B). For example, the course location, grading policies, meeting times, required texts, and other nonnumeric items of important information for “Class A” is then displayed under the “Class A” landing page on the mobile application for easy viewing.

Any dates extracted from the scanned syllabus is organized and linked to the item of information to which it corresponds 110 and 112. These dates are then used to populate the mobile application's calendar feature 114, with extracted items listed on the corresponding graphic display of dates on a typical calendar. The calendar is universal by default, displaying all important deadlines or dated items from all courses, but can be filtered to display only those of any one specific course or selection of courses (SEE FIG. 3C). The calendar can also be configured to display dates and schedules monthly, weekly or daily (SEE FIGS. 3F-I). The system uses these same extracted items and their corresponding dates to create and populate a “Newsfeed” 115 on the mobile application's homepage which lists all upcoming deadlines and dated items that may be approaching or near based on the date that the user views it (SEE FIG. 3A). Finally, if lesson topics or lecture names are listed with corresponding dates or are listed in any sequential order, the system uses this information to populate the “Archives” feature of the mobile application, which allows users to record audio and video from classes, or to upload photos of notes or other files organized by course and class date, available for viewing by all other users in the course (SEE FIGS. 3K-M).

Administrative Dashboard—Managers

FIG. 2E shows an exemplary Administrative Dashboard Diagram showing the process through which the system functions as a closed-loop standalone web application. This process is managed, edited, and controlled by a “Manager,” usually a school's IT Director, Principal, Department Chair, or otherwise authorized high-ranking School Administrator. By logging into the online dashboard via web browser and selecting “Users” on the dashboard's anchored navigation, the Manager is able to view and edit (add or remove) all current users in the school's database, whether “Teachers”, “Students” or other “Managers.” By selecting “Courses” on the dashboard's anchored navigation, the Manager can see every “Course” taught at the school and can add or remove any “Course.” Under this tab the Manager can also manually enter the necessary information usually gleaned from a scanned or uploaded syllabus in order to populate the mobile application with relevant “Course” data like dates, class times, and professor's office hours for end users to see. By selecting “Courses & Students” on the dashboard's anchored navigation, the Manager can view and edit class rosters for each “Course” in the system. By selecting “Syllabus” on the dashboard's anchored navigation, the Manager can manually add or remove any scheduled “Lesson” or topic listed on a given Course Syllabus and can add or remove assignments listed there as well.

All of the information found on the Dashboard can be entered manually by the Manager but much of it can also be entered manually by teachers or gleaned from a scanned or uploaded Syllabus. Much of the information including class rosters and other Course data can also be extracted from third-party servers or other learning management softwares, using LTI and API Rest data exchanges. (SEE FIG. 2A)

Administrative Dashboard—Teachers

FIG. 2F shows an exemplary diagram of the same dashboard as accessed by a “Teacher” and shows the process by which they are able to manually view, edit and control the “Courses” they teach. As “Power Users,” Teachers are able to access the online dashboard by logging in via web browser. Upon logging in, the home page includes anchored navigation that shows on the left of each page including the options “Courses,” “Students per Course,” and “Syllabus.” By selecting “Courses” on the dashboard's anchored navigation, the Teacher sees only the Courses for which they have been added as a “Teacher,” and are able to manually enter the necessary information usually gleaned from a scanned or uploaded syllabus in order to populate the mobile application with relevant data for each “Course” like dates, class times, and professor's office hours for end users to see. By selecting “Courses & Students” on the dashboard's anchored navigation, the Teacher can view and edit class rosters for each “Course” for which they are listed as “Teacher,” able to add or remove “Students.”

Mobile Application—Teachers and Managers

FIG. 2G shows an exemplary Mobile Application Diagram displaying the flow of the software as it is accessed by either a “Teacher” or a “Manager,” both of whom may be considered “Power Users.” Upon logging into the software application on a mobile device, the Teacher will see a home page that consists of a scrollable “Newsfeed” of upcoming important dates, assignments, and other notifications from every “Course” they teach, while a Manager will see those of every course. Though not yet depicted in the diagram, the notifications in this newsfeed can be dismissed, marked as completed, and filtered out by “Course” so that only certain items will be displayed. For example, a Manager will see every Course's notifications, but can easily filter through this by selecting a given Course name in the drop down list that appears when the “Filter” icon is selected. The Home-screen also allows the user to select from a drop down list of “My Courses” which takes the user directly to a selected “Course” and allows them to either “Scan a Syllabus” for that Course using the mobile device's camera, or to access the “Chat” thread for the Course, or to view and edit the uploaded documents and recordings under “Archives” for the Course. By selecting “Chat” the user is able to read and write messages to the Students in that Course. By selecting “Archive,” the user is able to view each file or document previously uploaded by Users in this Course, whether by student or teacher. The files are separated by type, whether “Photo,” “Audio,” “Video,” or “File,” and are further separated and sorted by the Course “Lesson” or “Topic” to which they relate or by the date on which they were uploaded. The user is also able to take or record and upload, photos, videos, audio, or previously stored files directly from this tab in the mobile application using the mobile device's camera, microphone, or internal storage.

The mobile application's home-screen also includes basic navigation with four options “Home” “Chat,” “Archive,” and “Calendar.” By selecting the “Home” icon on the navigation, the user is taken to the previously described home-screen with the “Newsfeed” and “My Courses” drop down list. By selecting “Chat,” the user is shown a list of their Courses to choose from and upon selecting a Course they are taken to that Course's chat thread as described above. By selecting the “Archive” icon on the mobile application's home-screen navigation, the user is shown a list of their Courses to choose from and upon selecting a Course they are taken to that Course's Archive of documents where they are able to view, record, and upload as described above. By selecting the “Calendar” icon on the anchored navigation, the user is taken to the calendar feature which combines information pulled from each class syllabus or Course into a graphic interface that shows daily and monthly schedules of important dates, assignments, specific lessons, quizzes, and tests from all the various courses all on one easy to read calendar.

Mobile Application—Student USer

FIG. 2H shows an exemplary Student User diagram illustrating the flow of the mobile application from the perspective of a “Student.” As seen in comparing the diagrams, the Student User's view and movement through the interface of the mobile application is identical to that of a power user but for one feature—the ability to scan a syllabus. This feature is reserved for Teachers, Professors and Administrators for purposes of continuity and efficiency—only one scan or upload of the syllabus is necessary to populate the application for every user registered in the Course.

Upon logging into the software application, the Student User will see a home page that consists of a static but scrollable “Newsfeed” of upcoming important dates, assignments, and other notifications from every “Course” they are enrolled in. Though not yet depicted in the diagram, the notifications in this newsfeed can be dismissed, marked as completed, and filtered out by “Course” so that only certain items will be displayed. For example, if a student may want to see only the notifications from “Spanish 101,” they can easily filter through this feed by selecting that Course name in the drop down list that appears when the “Filter” icon is selected. The Home screen also allows the student user to select from a drop down list of “My Courses” which takes them directly to a selected “Course” and allows them to either access the “Chat” thread for that Course or to view and edit the uploaded documents and recordings under “Archives” for the Course. By selecting “Chat” the Student is able to read and write messages to the Students in that Course. By selecting “Archive,” the user is able to view each file or document previously uploaded in this Course, whether by other students or by the teacher/professor. The files are separated by type, whether “Photo,” “Audio,” “Video,” or “File,” and are further separated and sorted by the Course's “Lessons” or “Topics” to which they relate or by the date on which they were uploaded. The user is also able to take or record and upload, photos, videos, audio, or previously stored files directly from this tab in the mobile application using the mobile device's camera, microphone, or internal storage.

The mobile application's home screen also includes basic navigation with four options: “Home” “Chat,” “Archive,” and “Calendar.” By selecting the “Home” icon on the navigation, the user is taken to the previously described home-screen with the “Newsfeed” and “My Courses” drop down list. By selecting “Chat,” the user is shown a list of their Courses to choose from and upon selecting a Course they are taken to that Course's chat thread as described above. By selecting the “Archive” icon on the mobile application's home-screen navigation, the user is shown a list of their Courses to choose from and upon selecting a Course they are taken to that Course's Archive of documents where they are able to view, record, and upload as described above. By selecting the “Calendar” icon on the anchored navigation, the user is taken to the calendar feature which combines information pulled from each class syllabus or Course into a graphic interface that shows daily and monthly schedules of important dates, assignments, specific lessons, quizzes, and tests from all the various courses all on one easy to read calendar.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

What is claimed is:

1. A method to manage learning for a student or group of students comprising:
capturing images of one or more syllabi using a mobile device;
detecting keywords in the one or more syllabi;
automatically placing the student into one or more student groups based on student class registrations;
determining deadlines based on requirements of the syllabi; and
generating notifications for the student based on the deadlines extracted from the one or more syllabi.

2. The method of claim 1, comprising capturing a recording for a class and storing the recording in a computer for subsequent access.

3. The method of claim 1, comprising determining deadlines for a homework, a quiz, or a test based on the information extracted from the one or more syllabi.

4. The method of claim 1, comprising creating a group chat for students enrolled in a course of study.

5. The method of claim 4, comprising creating the group chat based on school or university, course of study, class time and location, and professor and/or instructor name.

6. The method of claim 4, wherein a professor or instructor monitors the group chat and wherein students may discuss lectures, assignments, course topics.

7. The method of claim 1, comprising creating a mobililzed framework for following a course of study using key information extracted from that course's syllabus or written lesson plan.

8. The method of claim 2, comprising archiving of class recordings according to class schedule or course topic as listed in one or more syllabi.

9. The method of claim 1, comprising identifying due dates for projects, homework, quizzes, and exams.

10. The method of claim 9, comprising updating the due date or other course information by a professor.

11. The method of claim 1, comprising cumulating course meeting times and due dates for a plurality of courses and rendering the dates on a calendar.

12. The method of claim 1, comprising using an organized database of scanned images of syllabi and implementing algorithmic machine learning for improvement on the ability to identify and classify key words from the text extracted from these images;

13. The method of claim 1, comprising rendering a tab for a plurality of courses with a schedule breakdown of the courses displaying important dates.

14. The method of claim 1, comprising generating notifications that display upcoming deadlines and important dates for a course of study, or group thereof.

15. The method of claim 14, wherein the notifications page will consist of a compilation of all the important dates in a chronological display.

16. The method of claim 1, comprising storing access to class materials on a server and accessing the class materials on a computer or mobile device.

17. The method of claim 1, comprising uploading the images to a remote computer to perform optical character recognition.

18. The method of claim 1, comprising uploading the images to a remote computer to recognize text in the images.

19. The method of claim 1, comprising classifying the keywords into one of the following: course information, course dates and deadlines, course archives, course policies, course materials.

20. A system, comprising:
user mobile devices;
user computers; and
a server in communication with the devices and computers, the server running code for:
capturing images of one or more syllabi using the mobile devices and converting the images in to text;
detecting keywords from the text in the one or more syllabi;
automatically placing the student into one or more student groups based on student class registrations;
determining deadlines based on requirements of the syllabi; and
generating notifications for the student(s) based on the deadlines.
